(19) United States
(12) Patent Application Publication
(10) Pub. No.: US 2013/0139712 A1
(43) Pub. Date: Jun. 6, 2013

(54) ROLLER-BASED IMPRINTING SYSTEM

(71) Applicants: Yeeu-Chang Lee, Taoyuan County (TW); Tso-Hsiang Wu, Taoyuan County (TW); Bo-Ting Chen, Taoyuan County (TW)

(72) Inventors: Yeeu-Chang Lee, Taoyuan County (TW); Tso-Hsiang Wu, Taoyuan County (TW); Bo-Ting Chen, Taoyuan County (TW)

(21) Appl. No.: 13/484,561

(22) Filed: May 31, 2012

(30) Foreign Application Priority Data
Dec. 6, 2011 (TW) 100144906

(51) Int. Cl. B41F 3/02

(52) U.S. Cl. 101/250

(57) ABSTRACT

A roller-based imprinting system includes a roller module, a transmission module, a fixing module, a solidification module, and a controlling module. The roller-based imprinting system imprints and transfers a pattern located on the surface of a soft mold to the substrate through the pressing force of the roller.

### CROSS-REFERENCES TO RELATED APPLICATIONS

This non-provisional application claims priority under 35 U.S.C. § 119(a) on Patent Application No. 100144906 filed in Taiwan, R.O.C. on Dec. 6, 2011, the entire contents of which are hereby incorporated by reference.

### BACKGROUND

1. Technical Field

The disclosure relates to an imprinting device, and in particular to a roller-based imprinting system adapted to transfer a pattern of a soft mold onto a substrate.

2. Related Art

Nowadays, “minimal”, “light”, “thin”, “compact” with high performance are the main characteristics emphasized for electronic products; that also means the core components produced by semiconductor manufacturers have to be continuously developed in exactly the same directions. Currently the major bottle neck of technology development in semiconductor industry is linewidth size. When linewidth size becomes shorter, the size of a core component is able to be reduced as well. Regarding to performance, since a shorter linewidth allows faster power transmission speed yet lower power consumption, the performance of a semiconductor core component may be further enhanced.

Photo Lithography is the main process to manufacture core components in conventional semiconductor industry. However, in view of the optical aspect, since there is a physical limitation on focusing depth, even forming structural patterns on a plane with an extreme small curvature is still difficult to overcome, as well as the bottle neck of linewidth reduction. So far nano-scale Lithography technologies include Step and Repeat Lithography, E-beam Lithography, Ion-beam Lithography, Nanoimprint Lithography, etc.; wherein Nanoimprint Lithography is unrestricted by the optical interference limit and has certain features such as high resolution, high speed and low cost, thereby having broader application fields.

### SUMMARY

Accordingly, in an embodiment of the disclosure, a roller-based imprinting system is provided to transfer a pattern onto a substrate. The roller-based imprinting system includes a roller module, a transmission module, a soft mold and an electrical control module. The roller module includes a roller. The transmission module includes a movable stage disposed with the substrate thereon. The soft mold is located between the substrate and the roller; the soft mold has a pattern layer with the pattern formed thereon and facing the substrate. The electrical control module connected with the roller module and the transmission module, controls the roller to move in a first direction and controls the movable stage to move in a second direction toward an imprinting position; wherein the electrical control module controls the roller to press the soft mold for transferring the pattern of the pattern layer onto the substrate. In another embodiment, the roller module further includes a roller rotation motor, and the roller rotation motor is connected with the roller to rotate the roller with a rotation speed.

In another embodiment, the rotation speed is adapted to match with a moving speed of the movable stage for imprinting the pattern layer onto the substrate smoothly.

In another embodiment, the roller module further includes a roller upward-downward mechanism to drive the roller to move in the first direction. In some embodiment, the roller upward-downward mechanism is an air cylinder.

In another embodiment, the movable stage moves when the roller module reaches a positioning point, or both the roller module and the movable stage move into position respectively before a roll-based imprinting process.

In another embodiment, the soft mold is attached in advance or gradually attached on the roller for a roll-based imprinting process.

In another embodiment, the soft mold is covered in advance or gradually covered on the substrate for a roll-based imprinting process, wherein the soft mold is gradually covered on the substrate right before the soft mold moves under the roller.

In another embodiment, the transmission module includes a transmission motor for moving the movable stage, and further includes a linear movement device. The linear movement device is matchable with the transmission motor to make the movable stage move accordingly; and the linear movement device is selected from a group consisting of at least a screw shaft, a linear guideway, a guiding shaft and a rail or any combination thereof.

In another embodiment, the roller-based imprinting system includes a fixing module with plural air holes or air channels connecting a vacuum source or a vacuum generator to fix the substrate on the fixing module. In some embodiments, the vacuum source is an air-suction motor.

In another embodiment, a roller-based imprinting system is provided to transfer a pattern of a soft mold onto a substrate. The roller-based imprinting system includes a roller module, a transmission module, a continuous track module and an electrical control module. The roller module includes a roller. The transmission module includes a movable stage disposed with the substrate thereon. The continuous track module carries the soft mold to reach a position between the substrate and the roller; the soft mold has a pattern layer with the pattern formed thereon and facing the substrate. The electrical control module connected with the roller module and the transmission module, controls the roller to move in a first direction and controls the movable stage to move in a second direction toward an imprinting position;

wherein the electrical control module controls the roller to press the soft mold for transferring the pattern of the pattern layer onto the substrate. In another embodiment, the roller module includes a roller rotation motor, and the roller rotation motor is connected with the roller to rotate the roller with a rotation speed.

In another embodiment, the continuous track module includes a gear motor set, a track vacuum-bar set and a framework set.

### BRIEF DESCRIPTION OF THE DRAWINGS

The disclosure will become more fully understood from the detailed description given herein below for illustration only, and thus are not limitative of the disclosure, wherein:

FIG. 1 is a system block diagram of a roller-based imprinting system according to an embodiment;

FIG. 2 is an explanatory diagram of a roller module in a roller-based imprinting system according to another embodiment;

FIG. 3 is an explanatory diagram of a transmission module in a roller-based imprinting system according to another embodiment;

FIG. 4 is an explanatory diagram of a fixing module in a roller-based imprinting system according to another embodiment;

FIG. 5A, FIG. 5B is respectively an explanatory diagram of imprinting and transferring a pattern of a soft mold onto a substrate according to another embodiment;

FIG. 6A is an explanatory front view of a roller-based imprinting system according to another embodiment;

FIG. 6B is an explanatory lateral view of a roller-based imprinting system according to another embodiment;

FIG. 7A is an explanatory lateral view of a roller-based imprinting system that is imprinting a pattern onto a substrate according to another embodiment;

FIG. 7B is an explanatory diagram of imprinting a pattern onto a substrate according to another embodiment;

FIG. 8A is an explanatory diagram of setting up an angle of a light shade during light-solidification according to another embodiment, wherein the angle of the light shade from a normal line is 20°;

FIG. 8B is an explanatory diagram of setting up an angle of a light shade during light-solidification according to another embodiment, wherein the angle of the light shade from a normal line is 30°;

FIG. 8C is an explanatory diagram of setting up an angle of a light shade during light-solidification according to another embodiment, wherein the angle of the light shade from a normal line is 45°;

FIG. 9A is an explanatory front view of a roller-based imprinting system according to another embodiment; and

FIG. 9B is a system block diagram of a roller-based imprinting system according to another embodiment.

### DETAILED DESCRIPTION

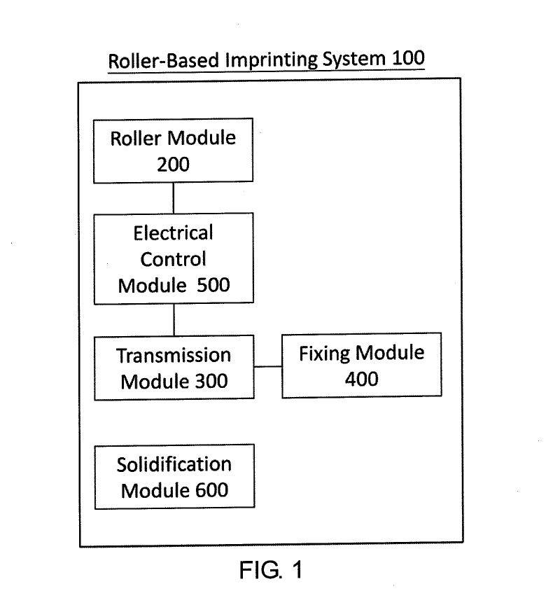

Refer to FIG. 1, which is a system block diagram of a roller-based imprinting system according to an embodiment. Roller-based imprinting system 100 mainly includes a roller module 200, a transmission module 300, a fixing module 400, an electrical control module 500, and a solidification module 600. The transmission module 300 is electrically connected with the fixing module 400 and the electrical control module 500. (or physically connected through a linking mechanism), thereby driving the fixing module 400 to move within the roller-based imprinting system 100, and controlling the position of the fixing module 400 by the electrical control module 500. A substrate for imprinting process is positioned on the fixing module 400. The roller module 200 is electrically connected with the electrical control module 500, such that the electrical control module 500 is able to adjust the positions of a roller of the roller module 200 to vertically press the substrate fixed on the fixing module 400. The solidification module 600 is located within the roller-based imprinting system 100 and adjacent to the transmission module 300, such that the transmission module 300 is able to transmit the fixing module 400 and the substrate thereon to the solidification module 600 for solidification process. The solidification module 600 may be independent from the roller module 200, or alternatively integrated with roller module 200 to reduce the manufacturing process. If the solidification module 600 is integrated into the roller module 200, a surface-solidification process after the imprinting process, or a linear solidification process refract through a transparent roller, is applied on solidification positions.

The roller module 200 mainly includes a roller rotation mechanism and a roller upward-downward mechanism. Mechanical actions of the roller module 200 include two major parts: roller rotation movements and roller upward-downward movements. When a roller-based imprinting process is activated, the roller upward-downward mechanism drives the roller to move into an imprinting position; when the roller-based imprinting process is completed, the roller upward-downward mechanism moves the roller back to a starting point; and during the roller-based imprinting process, a roller rotation motor drives the roller to rotate.

The imprinting position of the roller may be determined according to one of the following ways:

(1) using a “measurement system”, such as a digital screw micrometer, an optical meter, etc., to control a movement distance of the roller toward the imprinting position;

(2) using an “electrical-control motor system”, such as a step motor, a servo motor, etc., to control the movement distance of the roller toward the imprinting position; and

(3) using a “constant pressure system”; such as using an oil-pressure cylinder accompanying with an oil-pressure controller, or controlling output electric currents of a pilot motor (e.g., a step motor, a servo motor, etc.) to reach a constant pressure output, thereby controlling the movement distance of the roller toward the imprinting position.

A driving source of the roller upward-downward mechanism may be selected according to the different control mechanisms of the imprinting position, such as an air-pressure cylinder, an oil-pressure cylinder, a step motor, a servo motor, etc. Auxiliary roller upward-downward mechanisms, such as guiding shafts, screw shafts, linear guideways, rails, etc., may also be selected according to the corresponding driving source. Furthermore, an oil pressure buffer provides a buffer force opposite to the force of the roller upward-downward mechanism, so as to reduce the consumptions and abrasions of the components thereof caused by huge impacts.

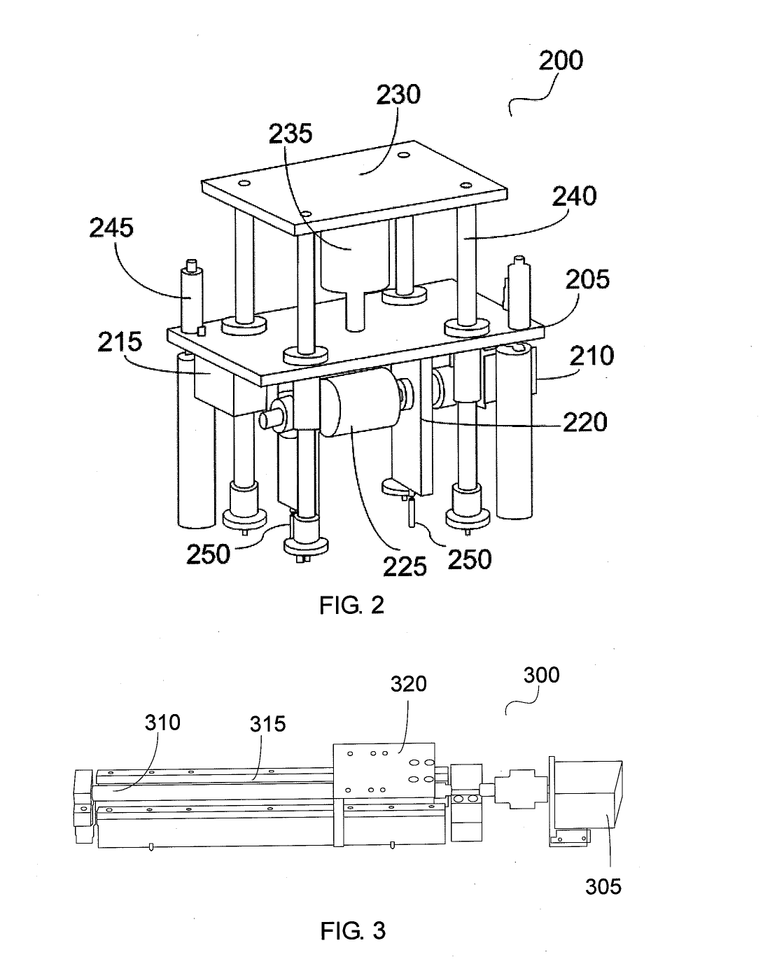

Refer to FIG. 2, which is an explanatory diagram of a roller module in a roller-based imprinting system according to another embodiment. Roller module 200 includes a roller platform 205, a roller rotation motor 210, a roller rotation motor balancing weight 215, a roller fixing base 220, a roller 225, an air-cylinder platform 230, a roller upward-downward air-cylinder 235, a guiding shaft 240, a screw micrometer 245, and a buffer 250. The roller upward-downward mechanism mainly includes the air-cylinder platform 230, the guiding shaft 240, the screw micrometer 245, and the buffer 250. The roller rotation mechanism mainly includes the roller rotation motor 210. The roller 225 is fixed on the roller platform 205 through the roller fixing base 220 and is connected with the roller rotation motor 210. The roller 225 may be transparent and made of glass or quartz, or be nontransparent. If the roller 225 is made of nontransparent materials, the solidification process may be performed after the imprinting process. The roller platform 205 is connected with the roller upward-downward air-cylinder or oil-cylinder 235, so that the roller 225 of the roller platform 205 may be driven by the roller upward-downward air-cylinder or oil-cylinder 235 to move vertically along the guiding shaft 240. The roller upward-downward air-cylinder or oil-cylinder 235 is assembled on the air-cylinder or oil-cylinder platform 230 and connects with an air or oil-pressure source (not shown). The air or oil-pressure source connected with the roller upward-downward air-cylinder or oil-cylinder 235 may be realized by an air or oil compressor; the air or oil pressure provided by the air or oil compressor may pass through a filter pressure-reducing valve (not shown) to filter impurities, as well as to adjust the output pressure, thereby controlling the output pressure of the roller upward-downward air-cylinder or oil-cylinder 235 and further adjusting the roller-based imprinting pressure. According to different product designs, the roller upward-downward air-cylinder or oil-cylinder 235 moves the roller 225 upward and downward by switching ON/OFF of an air or oil-pressure electrical valve; yet such design is not a general limitation to the disclosure. The roller rotation motor balancing weight 215 and the roller rotation motor 210 are installed at the left and right sides of the roller platform 205 respectively, opposite to each other, which ensures the weight balance of the roller platform 205 and avoids weight-unbalancing shortcomings resulted in unsmooth operations during upward/downward processes of the roller platform 205. The screw micrometer(s) 245 is located at diagonal position(s) on the roller platform 205. Through the relative positions between screw micrometer(s) 245 and a reference plane, the height of the roller platform 205 may be determined to avoid the shortcomings of the inclined roller platform 205. The buffer 250 provides a buffer force with a direction opposite to the moving direction of the roller platform 205, which ensures that all the components on roller platform 205 may be moved upward/downward smoothly and avoids the consumptions and abrasions caused by huge impacts. The roller rotation motor 210 is connected to the electrical control module 500, such that the electrical control module 500 is able to control a rotation speed of the roller 225 and ensures that a moving speed of the substrate driving by transmission module 300 is the same as a tangential speed of the roller 225 imprinting on the substrate, thereby avoiding a relative slip phenomenon between the substrate and a soft mold.

When the roller-based imprinting process is activated, the roller upward-downward mechanism (e.g. roller upward-downward air or oil-cylinder 235) moves the roller 225 to the imprinting position. When the imprinting process begins, the roller rotation motor 210 drives the roller 225 to start rotation. When the roller-based imprinting process is finished, the roller upward-downward mechanism moves the roller 225 back to a starting point. However, each of the components and parts may respectively move into position, namely move to each of their own positioning points.

Refer to FIG. 3, which is an explanatory diagram of a transmission module in a roller-based imprinting system according to another embodiment. Transmission module 300 includes a transmission motor 305, a screw shaft 310, a slide guideway 315 and a movable stage 320. The transmission motor 305 is connected with screw shaft 310, and screw shaft 310 is connected with the movable stage 320, such that the transmission motor 305 is able to drive screw shaft 310 and the screw shaft 310 may further drive the movable stage 320 to move accordingly. The transmission motor 305 also connects with the electrical control module 500 which is able to control the speed of the transmission motor 305. The movable stage 320 is used to install the fixing module 400. The screw shaft 310 is a linear movement device. For example, a ball screw shaft has a coupling 325 part engaged with transmission motor 305 to act synchronously and move the movable stage 320 along a horizontal direction; wherein the moving direction of the movable stage 320 is vertical from the moving direction of the roller 225. The screw shaft 310 may be replaced by other convex-concave structures or components, such as slide guideways, guide shaft and rails, to perform a linear reciprocatory movement. The slide guideway 315 may be a linear guideway to prevent the movable stage 320 from turning problems during movement, as well as to help the screw shaft 310 to remain a linear movement and balance the loadings. Based on different product design requirements, more than one slide guideway may be used; yet which should not become any limitation to the disclosure. In another embodiment, the transmission module 300 further includes a movable stage starting-point sensor and a movable stage end-point sensor (not shown) for detecting the position of the movable stage 320; both of the two sensors are connected with the electrical control module 500. The electrical control module 500 controls the transmission motor 305 to drive the screw shaft 310 so that the movable stage 320 may have a forward linear movement guided by the slide guideway 315. After the movable stage 320 activates the movable stage end-point sensor and sends a corresponding activation signal to the electrical control module 500, the electrical control module 500 starts to control the transmission motor 305 to change the moving direction. The movable stage 320 may still be guided by the slide guideway 315 to have a backward linear movement until the movable stage 320 activates the movable stage starting-point sensor and send another corresponding activation signal to the electrical control module 500, then the electrical control module 500 stops the operation of transmission module 300.

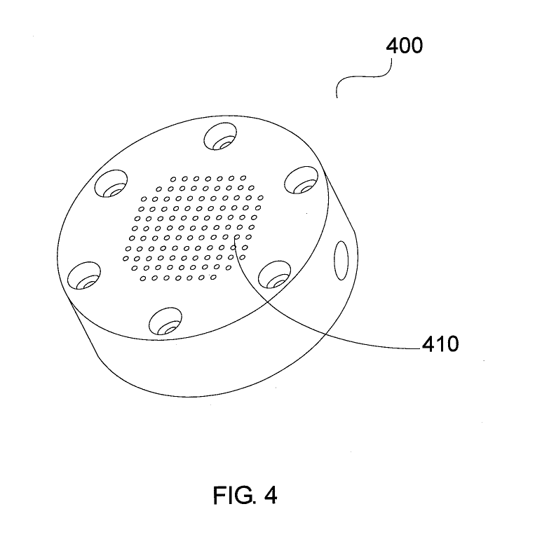

In some embodiments, the fixing module 400 is realized by vacuum suction, concave slot fixing, check block fixing or pin fixing technologies, to fix the substrate thereon. If the vacuum suction technology is applied, please refer to FIG. 4, which is an explanatory diagram of a fixing module in a roller-based imprinting system according to another embodiment. The fixing module 400 includes multiple air holes 410 or air channels (not shown) and connects with a vacuum source, such as an air-suction motor (not shown). A suction force is formed on the surface of fixing module 400 when the air-suction motor is sucking air through the air holes 410; such suction force fixes the substrate on top of the fixing module 400 for the imprinting process. The air-suction motor may be a vacuum pump. The fixing module 400 is further fastened on the movable stage 320 of the transmission module 300 by fastening element(s) (not shown), so fixing module 400 may be moved accompanying with movable stage 320.

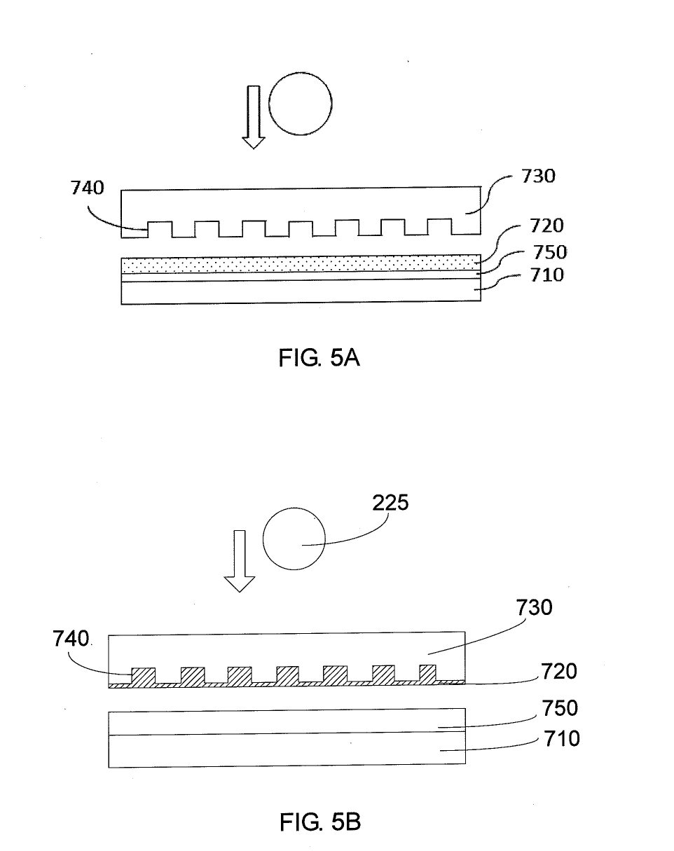

Refer to FIG. 5A and FIG. 5B, which is respectively an explanatory diagram of imprinting and transferring a pattern of a soft mold onto a substrate according to another embodiment. The substrate 710 fastened on the fixing module 400 includes a imprinting material 720. A soft mold 730 with a pattern layer 740 is used to imprint and transfer a pattern formed by the convex-concave structures of pattern layer 740 onto the imprinting material 720 of the substrate 710. When the substrate 710 is fastened on the fixing module 400 of the movable stage 320, the pattern layer 740 of the soft mold 730 is adapted to face the substrate 710. The imprinting material 720 is adapted to be formed on the substrate 710, between substrate 710 and soft mold 730. Accompanying with product design requirements, an interface layer 750 may be formed on the imprinting material 720, between the imprinting material 720 and the substrate 710, to increase the attaching force between substrate 710 and imprinting material 720. In an embodiment, interface layer may be made of HDMS (Hexamethyl Disilazane). The soft mold 730 may be formed by PDMS (Polydimethylsiloxane). The imprinting material 720 may be applied on the substrate 710 in advance, and the pattern of the soft mold 730 is duplicated on to the imprinting material 720 through the imprinting process of the roller 225. According to different product design requirements, the imprinting material may be applied on the soft mold 730 as well as the pattern layer 720 of the soft mold 730, and then such imprinting material 720 may be attached and covered onto the substrate 710 through the imprinting process of the roller 225, such that the pattern of the soft mold 730 is duplicated on to the imprinting material 720. According to different requirements of manufacturing processes, the soft mold 730 may be attached in advance or gradually attached on the imprinting material 720 to proceed with the imprinting process of the roller 225; or, the soft mold 730 may be attached in advance or gradually attached on the roller 225 for the imprinting process of the roller 225.

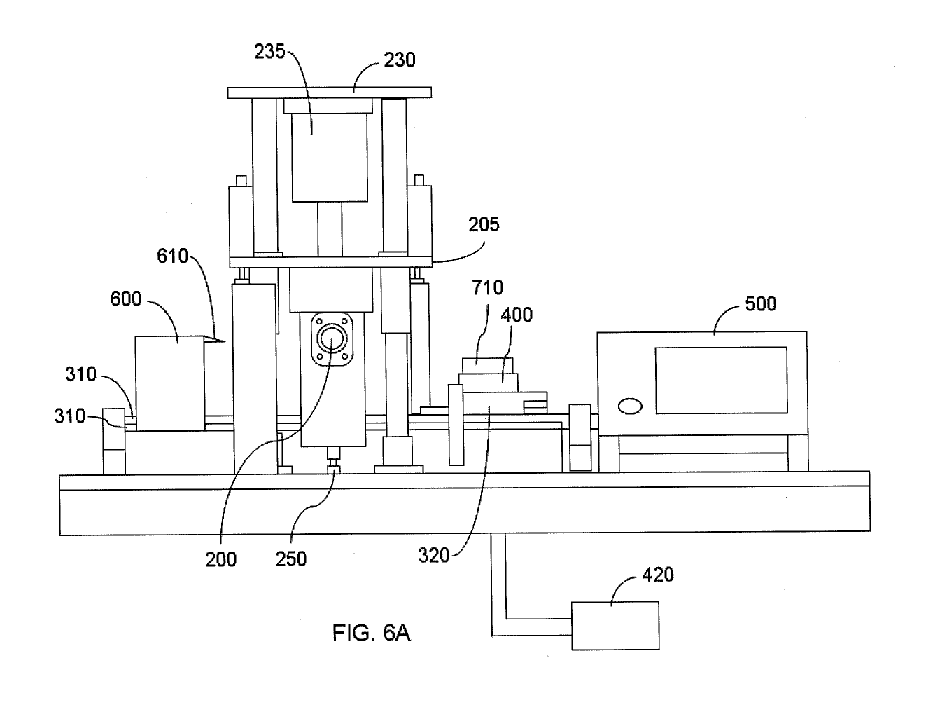

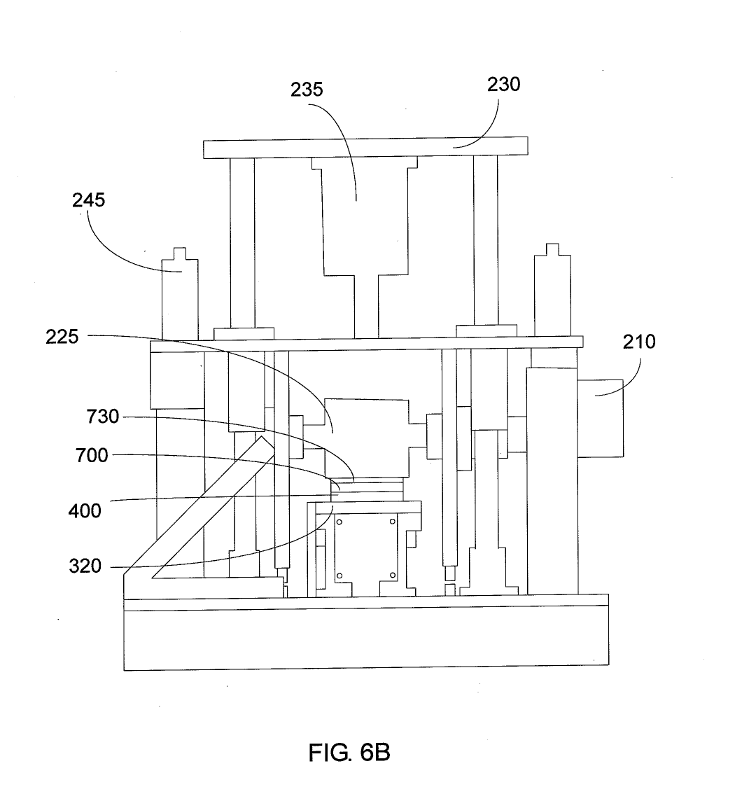

Refer to FIG. 6A and FIG. 6B. FIG. 6A is an explanatory front view of a roller-based imprinting system according to another embodiment; while FIG. 6B is an explanatory lateral view of a roller-based imprinting system according to another embodiment. First of all, the fixing module 600 is disposed on the movable stage 320. After the substrate 710 is disposed on the fixing module 600, activate the air-suction motor 420 to fix the substrate 710 on top of the fixing module 600. Next, the electrical control module 500 controls the roller 225 to lower toward an imprinting position and to start rotation; in the meantime, the transmission motor 305 of the transmission module 300 starts to operate and drive the movable stage 320 to move straight by the transformation of screw shaft 310 from a rotation movement into a linear movement. The movable stage 320 is kept moving until the movable stage 320 activates the movable stage endpoint sensor. The moving direction of the roller 225 is defined as a first direction and the moving direction of the movable stage 320 is defined as a second direction.

Also, the moving direction of the roller 225 is vertical from the moving direction of movable stage 320; namely the first direction is vertical from the second direction. In an embodiment, the first direction is a vertical direction and the second direction is a horizontal direction. Moreover, the roller 225 may be moved into position for imprinting at the same time as the movable stage 320. During the process that the movable stage 320 carries the substrate 710 and move, the roller 225 is about to contact with the soft mold 730. Through the control of the electrical control module 500 on the speed of each of the transmission motor 305 and the roller rotation motor 210, the substrate 710 and the soft mold 730 are synchronously moved to complete the imprinting process. The soft mold 730 is carried to reach a position between the roller 225 and the substrate 710; also the roller 225 may provide a pressure to the soft mold 730 and the substrate 710 at same time, such that the pattern of the pattern layer 740 of the soft mold 730 may be imprinted and transferred on to the substrate 710.

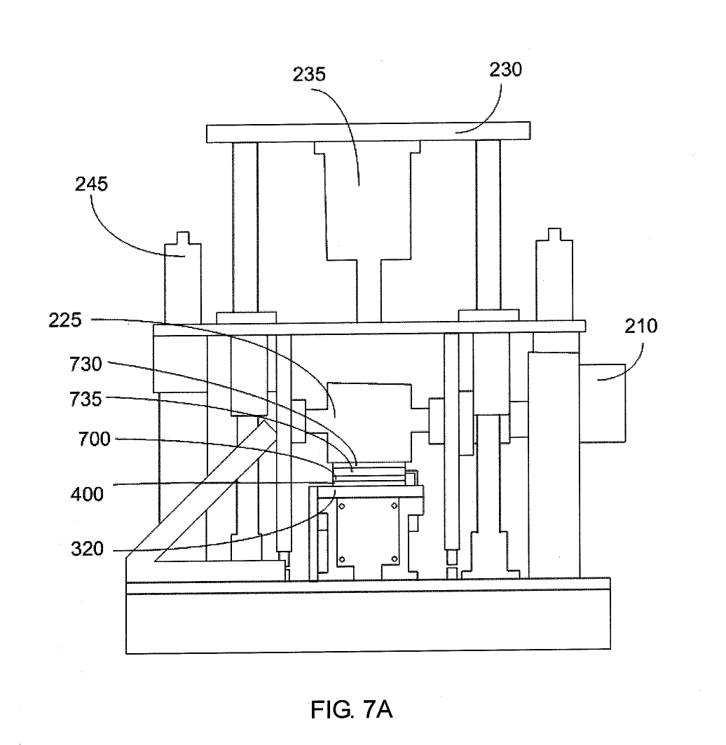

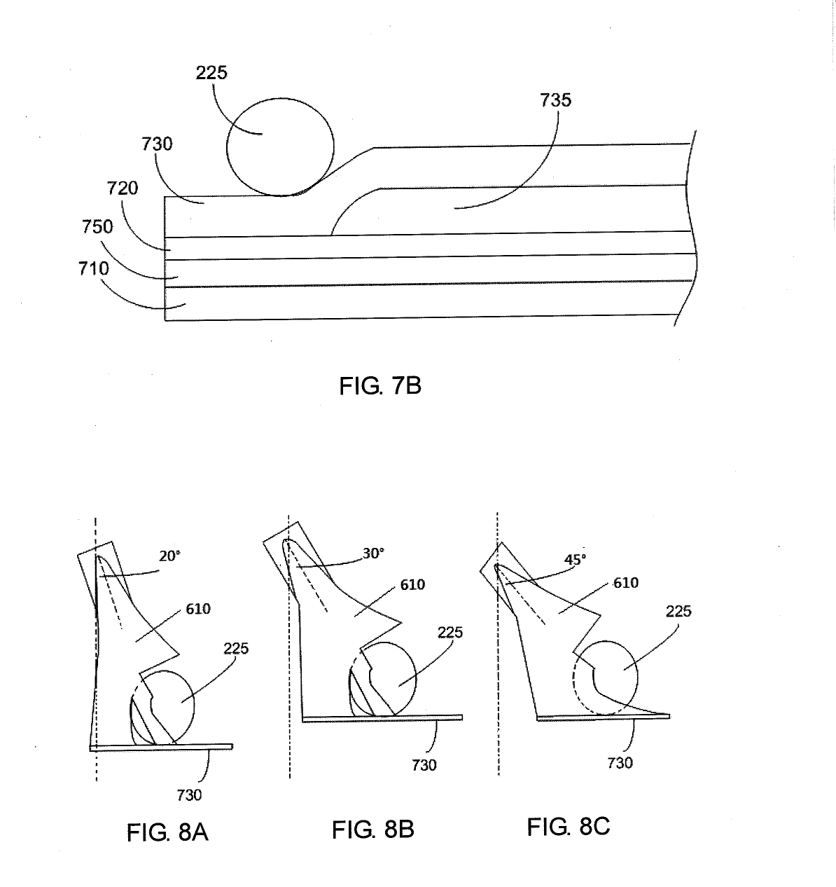

Besides, the soft mold 730 may be gradually attached on the surface of the roller 225 upon the beginning of the imprinting process. Alternatively, the soft mold 730 may be gradually covered on substrate 710, right before the soft mold 730 moves through the roller 225, as shown in FIG. 7A and FIG. 8A. In FIG. 7A, a support structure 735 makes the soft mold 730 attached with the substrate 710 right before the substrate 710 moving through the roller 225. Refer to FIG. 7B for detailed structures. The above mentioned way may prevent air bubbles from existing between the soft mold 730 and the substrate 710.

In another embodiment of the disclosure, the solidification module 600 is integrated into the roller module 200 to conduct a linear solidification process. During the imprinting process, the solidification module 600 have a light source and a light shade 610 that restricts the scattering phenomenon of the light source to pass through roller 225, such as a transparent quartz roller; through the refraction of the transparent roller 225, the lights of the light source is focused on a contact area between the roller 225 and the soft mold 730, such that solidification may be performed at the same time as the imprinting process. The light source of solidification module 600 may be an ultraviolet light source; the solidification target is undoubtedly the portions of imprinting material 720 after the imprinting process. Once the movable stage 320 activates the movable stage end-point sensor, the roller 225 stops self-rotating and is raised to a starting point. After the roller 225 returns to the starting point, the transmission motor 305 of the transmission module 300 also starts a return process; through the transformation of the screw shaft 310 from the rotation movement into the linear movement, the movable stage 320 is carried backward in the reverse direction. The transmission motor 305 keeps operating until the movable stage 320 activates the movable stage start-point sensor. When movable stage 320 activates the movable stage start-point sensor, the electrical control module 500 turns off the air-suction motor 420 such that the imprinted substrate 710 may be removed from the fixing module 400.

The light source and the light shade may be adapted to control the output angle. Refer to

FIG. 8A, FIG. 8B and FIG. 8C. When the output angle of the light source differs, since the cross section of roller 225 is round, the refraction result of lights passing through roller 225 is different; also the efficiency of solidification varies accordingly. In FIG. 8C, the illuminating area of the ultraviolet light source is greater; while in FIG. 8A, a focus effect will be generated. In the present embodiment, aiming to the solidification module 600 with the ultraviolet light source, a software kit for optical simulation called LightTool is used for simulation analysis of light shades, illuminations of ultraviolet lights and illuminating areas. Then the light shades 610 are further produced and actually installed on the solidification module 600. The simulation results indicates if the angle between the illuminate direction and the normal line is greater, the illumination focus center is farther from the imprinting contact line, the focus energy is gradually decreased and also the focus area is in inverse proportion with the angle. Further simulation may be performed according the results above, such as simulations about the light shade angle and the relations with light refraction when passing the roller. The simulation results indicates that, the optimal performance is achieved if the light shade 610 limits the illuminating direction to pass and reflect at the imprinting contact line of the roller 225 and the substrate 710 with an angle of 70°; wherein the illumination range is controlled to illuminate on only those behind the imprinting contact line of roller 225 and the substrate 710 and also the average illumination has to reach certain requirements.

Regarding how the soft mold may be gradually attached on the roller or gradually covered on the substrate for the imprinting process, for example, a continuous track module may be used to carry the soft mold and realized the above-mentioned processes.

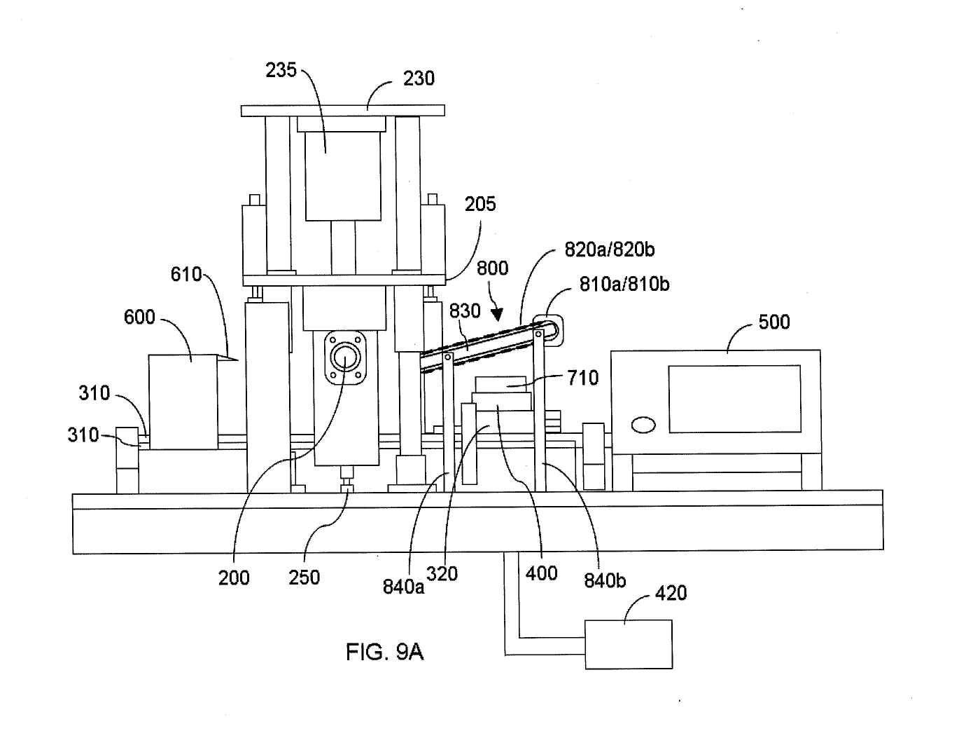

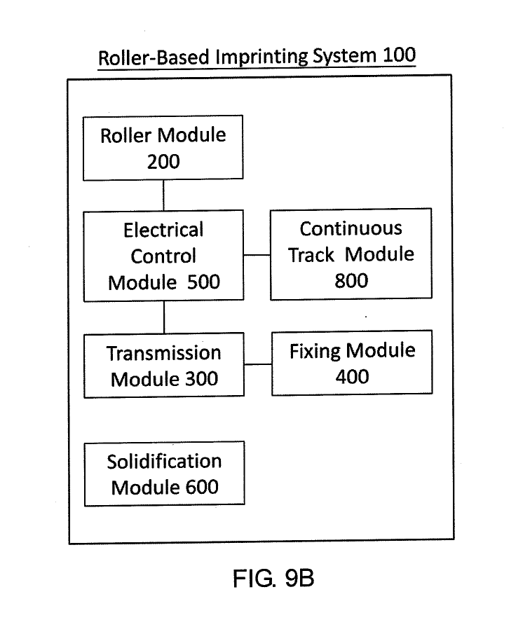

Please refer to FIG. 9A and FIG. 9B. FIG. 9A is an explanatory front view of a roller-based imprinting system according to another embodiment; and FIG. 9B is a system block diagram of a roller-based imprinting system according to another embodiment. In another embodiment, the roller-based imprinting system 100 includes the roller module 200, the transmission module 300, the fixing module 400, the electrical control module 500, the solidification module 600 and the continuous track module 800. Most of these modules are similar to those disclosed in previous embodiments and drawings, and thereby no repeated descriptions are necessary. The continuous track module 800 is adapted to carry the soft mold 730 and transmit to a position between the substrate 710 and the roller 225; depending on actual needs, the soft mold 730 may be gradually attached on the roller 225 or gradually covered on the substrate 710 for the roll-based imprinting process.

The continuous track module 800 is formed by a gear motor set, a track vacuum-bar set and a framework set. The gear motor set includes at least a motor 810a, one or more gears 810b linked with the motor 810a and/or the track vacuum-bar set, and shaft bearing(s) (not shown) for connecting the corresponding gears 810b. The track vacuum-bar set is formed by two parallel continuous tracks 820a installed on the gear 810b, and multiple vacuum bars 820b assembled between the two parallel continuous tracks 820a. The framework set includes two parallel main supports 830, and multiple foot supports 840a/840b for supporting the main supports 830. The motor 810a, the gear 810b and the shaft bearing(s) of the gear motor set are directly or indirectly assembled on the main support 830 of the framework set. The motor 810a may operate according to the control of electrical control module 500 and drives the gear(s) 810b. The vacuum bars 820b on the continuous tracks 820a include air holes or channels thereon to be linked with the air-suction motor 420, so the soft mold 730 may be vacuumed and fixed on the vacuum bars 820b. Based on different needs of design or manufacture processes, when the soft mold 730 is carried by the continuous track module 800 to reach a position between the substrate 710 and the roller 225, the soft mold 730 may be gradually attached onto the surface of roller 225, or gradually covered on the substrate 710. As long as the pattern layer 740 of the soft mold 730 is adapted to face the substrate 710, the pattern of the pattern layer 740 may be transferred to the substrate 710 through the imprinting process

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A roller-based imprinting system, adapted to transfer a pattern onto a substrate, comprising:
a roller module, having a roller;
a transmission module, having a movable stage with the substrate disposed thereon;
a soft mold, carried to move between the substrate and the roller, the soft mold having a pattern layer with the pattern formed thereon and facing the substrate; and
a control module connected with the roller module and the transmission module, controlling the roller to move in a first direction and controlling the movable stage to move in a second direction toward an imprinting position, wherein the control module controls the roller to press the soft mold and transfers the pattern of the pattern layer onto the substrate.

2. The roller-based imprinting system according to claim 1, wherein the roller module comprising a roller rotation motor, the roller self-rotation motor being connected with the roller to rotate the roller with a rotation speed.

3. The roller-based imprinting system according to claim 2, wherein the rotation speed is adapted to match with a moving speed of the movable stage for imprinting the pattern layer onto the substrate smoothly.

4. The roller-based imprinting system according to claim 1, wherein the roller module further comprises a roller upward-downward mechanism to drive the roller to move in the first direction.

5. The roller-based imprinting system according to claim 1, wherein the movable stage moves when the roller module reaches a positioning point, or both the roller module and the movable stage move into position together before a roll-based imprinting process.

6. The roller-based imprinting system according to claim 1, wherein the soft mold is attached in advance or gradually attached on the roller for a roll-based imprinting process.

7. The roller-based imprinting system according to claim 1, wherein the soft mold is covered in advance or gradually covered on the substrate for a roll-based imprinting process.

8. The roller-based imprinting system according to claim 1, wherein the transmission module further comprises a linear movement device, the linear movement device being matchable with a transmission motor to make the movable stage move accordingly, and the linear movement device being selected from a group consisting of at least a screw shaft, a linear guideway, a guiding shaft and a rail or any combination thereof.

9. The roller-based imprinting system according to claim 1 further comprising a fixing module with a plurality of air holes or air channels connecting a vacuum source to fix the substrate on the fixing module.

10. The roller-based imprinting system according to claim 1 further comprising a solidification module adjacent to the transmission module, which is adapted to guide lights of the solidification module to a contact position of the roller and the soft mold through a light shade of the solidification module, wherein the solidification module having a ultraviolet light source.

11. A roller-based imprinting system, adapted to transfer a pattern of a soft mold onto a substrate, comprising:
a roller module with a roller;
a transmission module, having a movable stage disposed with the substrate thereon;
a continuous track module, carrying the soft mold to move between the substrate and the roller, the soft mold having a pattern layer with the pattern formed thereon and facing the substrate; and
a control module connected with the roller module and the transmission module, controlling the roller to move in a first direction and controlling the movable stage to move in a second direction toward an imprinting position, wherein the control module controls the roller to press the soft mold and transfers the pattern of the pattern layer onto the substrate.

12. The roller-based imprinting system according to claim 11, wherein the roller module comprises a roller rotation motor, the roller self-rotation motor being connected with the roller to rotate the roller with a rotation speed.

13. The roller-based imprinting system according to claim 12, wherein the rotation speed is adapted to match with a moving speed of the movable stage for imprinting the pattern layer onto the substrate smoothly.

14. The roller-based imprinting system according to claim 11, wherein the roller module further comprises a roller upward-downward mechanism to drive the roller to move in the first direction.

15. The roller-based imprinting system according to claim 11, wherein the movable stage moves when the roller module reaches a positioning point, or both the roller module and the movable stage move into position together for a roll-based imprinting process.

16. The roller-based imprinting system according to claim 11, wherein the soft mold is carried by the continuous track module to be gradually attached on the roller or gradually covered on the substrate for a roll-based imprinting process.

17. The roller-based imprinting system according to claim 11, wherein the continuous track module comprises a gear motor set, a track vacuum-bar set and a framework set.

18. The roller-based imprinting system according to claim 11, wherein the transmission module further comprises a linear movement device, the linear movement device being matchable with a transmission motor to make the movable stage move accordingly, and the linear movement device being selected from a group consisting of at least a screw shaft, a linear guideway, a guiding shaft and a rail or any combination thereof.

19. The roller-based imprinting system according to claim 11 further comprising a fixing module with a plurality of air holes or air channels connecting a vacuum source to fix the substrate on the fixing module.

20. The roller-based imprinting system according to claim 11 further comprising a solidification module adjacent to the transmission module, the solidification module having a light shad adapted for guiding lights of the solidification module to a contact position between the roller and the soft mold, wherein the solidification module having a ultraviolet light source.
